(19) United States
(12) Patent Application Publication
(10) Pub. No.: US 2013/0080879 A1
(43) Pub. Date: Mar. 28, 2013

(54) Methods and apparatus providing document elements formatting

(71) Applicants: Danielle B. Darling, Seattle, WA (US); Yeming Liu, Kirkland, WA (US)

(72) Inventors: Danielle B. Darling, Seattle, WA (US); Yeming Liu, Kirkland, WA (US)

(21) Appl. No.: 11/159,652

(22) Filed: Jun. 23, 2005

(51) Int. Cl. G06F 17/21

(52) U.S. Cl. CPC G06F 17/212
USPC 715/243

(57) ABSTRACT

A system implements a style within a graphical user interface application by defining a style containing sets of attributes, each set respectively associated with a different type of display element. A user, using the system, defines a display element for display within the graphical user interface. The system then applies, to the display element, respective attributes of the style that correspond to a type of the display element; and displays the display element in accordance with the applied respective attributes of the style.

### BACKGROUND

Conventional graphical design software packages, such as desktop publishing packages, allow a user to manipulate document elements (i.e., graphics, images, frames, text, etc) to create professional quality literature such as brochures, marketing materials, web pages and the like, both for use online and in printed form. Using such packages, a user creates and arranges document elements within a graphical user interface to create a document, and then formats (i.e., applies attributes such as color, shading, etc) those elements (i.e., graphics, frames, text) to create a consistent look across the whole document, and across related documents.

A user formats document elements by either manually applying individual attributes to each respective document element (i.e., graphics, images, frames, text, etc), or by applying a predefined style to such document elements. A style saves the user the time of repetitively applying a common set of attributes to various document elements. For example, a conventional text style might contain a list of attributes to be applied to a block of selected text, such as Times New Roman font; twelve point font size, bold and underlined. A conventional desktop publishing software package can have many predefined styles, each applicable to a specific type of document element. Thus there can be text styles for text elements, graphic styles for graphic elements, and so forth. A user can select a document element such as a block of text and can apply a selected style appropriate for that type of document element (e.g. a text style for a text element) for application to the selected document element(s). In response, the conventional desktop publishing software applies the attributes of the selected style to the selected document element(s). The user can also duplicate and re-use formatted document elements. Formatted document elements can also be stored in a palette library, and inserted into the document via the graphical user interface, saving the user the need to re-create those document elements with the specific selected attributes each time those document elements are needed.

### SUMMARY

Conventional technologies for implementing formatting styles for document elements within a graphical user interface suffer from a variety of deficiencies. In particular, conventional technologies that implement formatting styles for document elements are limited in that they require a user to manually select each document element and then apply a formatting style to each document element when creating or modifying a display element. Such conventional approaches also require different versions of each formatting style for each of the different types of document elements (i.e., graphics, images, frames, text, etc). For example, implementing a bold attribute for text requires implementing a different formatting style (i.e. a bold text style) than implementing a bold attribute for frames (i.e. a bold frame style). Conventional style mechanisms do not support defining a style with attributes for many different types of document elements, so of which might not apply to some document elements, while other may apply. For example, using conventional systems, a user cannot define a style with text attributes that would be applied to text document element but not graphics elements, and in the same style define graphics attributes that would apply to graphics elements but not text elements. Additionally, if the attributes of a particular formatting style are modified or updated, the user has to manually update all of the document elements that have been formatted with that style for the style changes to take effect.

Conventional technologies for implementing formatting styles for document elements are also limited in their extensibility and flexibility. If a formatting style is proprietary, it is difficult to extend an existing formatting style to include the additional proprietary attributes, and then to propagate that proprietary style to all the respective types of document elements once changed. Conventional technologies for implementing formatting styles for document elements do not allow a user to override an attribute that is defined within a formatting style, resulting in a lack of flexibility in the implementation of formatting styles.

Embodiments disclosed herein significantly overcome such deficiencies and provide a system that includes a computer system executing a style implementation process for a graphical user interface application. Using the style implementation process, a user defines a style (i.e., a document element formatting style) containing sets of attributes, each set of attributes respectively associated with a different type of display element, such as a graphic, image, frame, or text. Using the style implementation process, the user defines a display element for display within the graphical user interface, and applies, to the display element, the respective attributes of the style that correspond to a type of the display element. Thus, a single style can contain attributes for different types of document elements and thus a software application implementing the style definition and application processing disclosed herein can apply a style as defined herein to any type of document element (i.e., graphics, images, frames, text, etc). If the attributes within the style need to be updated, the update is performed within the style, and the style implementation process disclosed herein automatically applies those changes to all document elements that are formatted with that style (which can include document elements of different types, such as graphics document elements, text document elements, and so forth), saving the user from individually updating each document element formatted with that particular style, within a single document, or across any related documents. The style implementation process then displays the display element in accordance with the applied respective attributes of the style that apply to that display element type.

The style implementation process allows further extensibility by allowing a third party provider to add their proprietary attributes to an existing style. The style implementation process provides an easier technique for a third party provider to implement their styles by standardizing the process of implementing the style attributes, rather than each third party provider implementing new attributes using a variety of implementation methods. Non-standardized implementation methods create a variety of problems for future updates, especially when new users, unfamiliar with the previously used implementation methods, are tasked with coding the updates. The style implementation process provides flexibility by allowing a third party to override the style's existing attributes. The user can also turn off or on attributes when applying the style to document elements, thus allowing selective application of attributes within a style to various different types of display elements to which that style is applied.

During an example operation of one embodiment, suppose a user, such as a third party provider, wants to implement a drop shadow style to a display element, such as for example, a text or graphical object. The user defines a style, for example, a drop shadow style object, containing sets of attributes, each set respectively associated with a different type of display element that can be formatted with attributes associated with a drop shadow effect. To create the drop shadow style object, the user first creates a non-persistent object, for example, a drop shadow style target. The drop shadow style target contains attribute lists for the different types of display elements that the drop shadow style object is capable of formatting. Within the drop shadow style target, the user defines the attributes associated with the drop shadow style for-each of the different types of display elements. Thus the user can define a drop shadow effect for text with drop shadow text attributes, and a drop shadow effect for graphics with drop shadow graphics attributes, and so forth (i.e., for other types of display elements). The user derives a persistent drop shadow style object from the non-persistent drop shadow style target. As a result of this derivation, the drop shadow style object inherits the attribute lists (i.e. for the different types of display elements) previously defined in the drop shadow style target. It should be noted that, in terms of Object Oriented coding, the term ‘derived’ has a very specific meaning to anyone who is skilled in the art. Deriving an object from another object means defining a first class, then deriving an instance of a second class from that first class, with the second class inheriting all the characteristics and features of the first class. A programmer can add additional features to the second class, if necessary. This saves the programmer from having to redefine the second class. Plus, any modifications to the first class get automatically propagated to any subsequent classes (i.e. the second class, a third class, etc) that are derived from the first class.

Within the graphical user interface, using the style implementation process, the user defines a display element. The user applies the drop shadow effect attributes to the display element by applying the style to that elements, which results in application of the respective drop shadow effect attributes for that type of display element (the drop shadow effect attributes that were defined within the drop shadow style target for that type of display element, and inherited from the drop shadow style target by the drop shadow style object). The style implementation process then displays the display element formatted with the attributes that were defined within the drop shadow style object. Should a third party provider need to modify or update the attributes for any drop shadow style object, the third party provider would only have to update the attributes in the drop shadow style object to update any display element formatted with the drop shadow effect.

Since the style definition and application techniques disclosed herein allow defining attributes for many different types of display elements in a single style, the user does not need to track similar different styles for different types of display elements, as in conventional systems. For example, using the drop shadow example, suppose a drop shadow graphics attribute defines how a drop shadow should appear at a location of two intersecting edges (e.g., a corner of a box) of a graphic display element. This example drop shadow graphics attribute might have no meaning or applicability to a text display element. In a similar manner, the same style containing that attribute for graphics display elements might contain one or more text drop shadow attributes that would have no applicability to graphics display elements but that would define how a drop shadow should be applied to text. The system disclosed herein thus allows the definition of a style to provide an effect such as drop shadow, no matter what display element the effect is being applied to.

Other embodiments of the disclosed herein include any type of computerized device, workstation, handheld or laptop computer, or the like configured with software and/or circuitry (e.g., a processor) to process any or all of the method operations disclosed herein. In other words, a computerized device such as a computer or a data communications device or any type of processor that is programmed or configured to operate as explained herein is considered an embodiment disclosed herein.

Other embodiments that are disclosed herein include software programs to perform the steps and operations summarized above and disclosed in detail below. One such embodiment comprises a computer program product that has a computer-readable medium including computer program logic encoded thereon that, when performed in a computerized device having a coupling of a memory and a processor, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained herein as embodiments disclosed herein.

It is to be understood that the system disclosed herein may be embodied strictly as a software program, as software and hardware, or as hardware alone. The features disclosed herein, as explained herein, may be employed in data communications devices and other computerized devices and software systems for such devices such as those manufactured by Adobe Systems, Inc. of San Jose, Calif.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a high-level block diagram of a computer system according to one embodiment disclosed herein.

FIG. 2 shows coding examples of a style data object, and a style object defined by the system of FIG. 1, according to one embodiment disclosed herein.

FIG. 3 shows a coding example of a style handler defined by the system of FIG. 1, according to one embodiment disclosed herein.

FIG. 4 illustrates a flowchart of a procedure performed by the system of FIG. 1 when the style implementation process defines a style, according to one embodiment disclosed herein.

FIG. 5 illustrates a flowchart of a procedure performed by the system of FIG. 1 when the style implementation process defines a style, according to one embodiment disclosed herein.

FIG. 6 illustrates a flowchart of a procedure performed by the system of FIG. 1 when the style implementation process creates style data, according to one embodiment disclosed herein.

FIG. 7 illustrates a flowchart of a procedure performed by the system of FIG. 1 when the style implementation process applies, to the display element, respective attributes of the style that correspond to a type of the display element, according to one embodiment disclosed herein.

FIG. 8 illustrates a flowchart of a procedure performed by the system of FIG. 1 when the style implementation process defines a style, according to one embodiment disclosed herein.

FIG. 9 illustrates a flowchart of a procedure performed by the system of FIG. 1 when the style implementation process defines a display element for display within the graphical user interface, according to one embodiment disclosed herein.

FIG. 10 illustrates a flowchart of a procedure performed by the system of FIG. 1 when the style implementation process defines a style data object, according to one embodiment disclosed herein.

### DETAILED DESCRIPTION

Embodiments disclosed herein include a computer system that performs a style implementation process that allows a user to define a style (for a display element) containing sets of attributes, each set of attributes respectively associated with a different type of display element (i.e., graphics, images, frames, text, etc). The style implementation process allows a user to define a display element for display within the graphical user interface, and then apply to the display element, the respective attributes of the defined style that correspond to the type of display element defined by the user. The style implementation process then displays the display element formatted with the attributes defined for the display element, and applied to the display element by the user. Further details concerning the unique manner in which the system disclosed herein provides definition, application and extensibility of styles will now be provided with respect to the Figures and the discussion below.

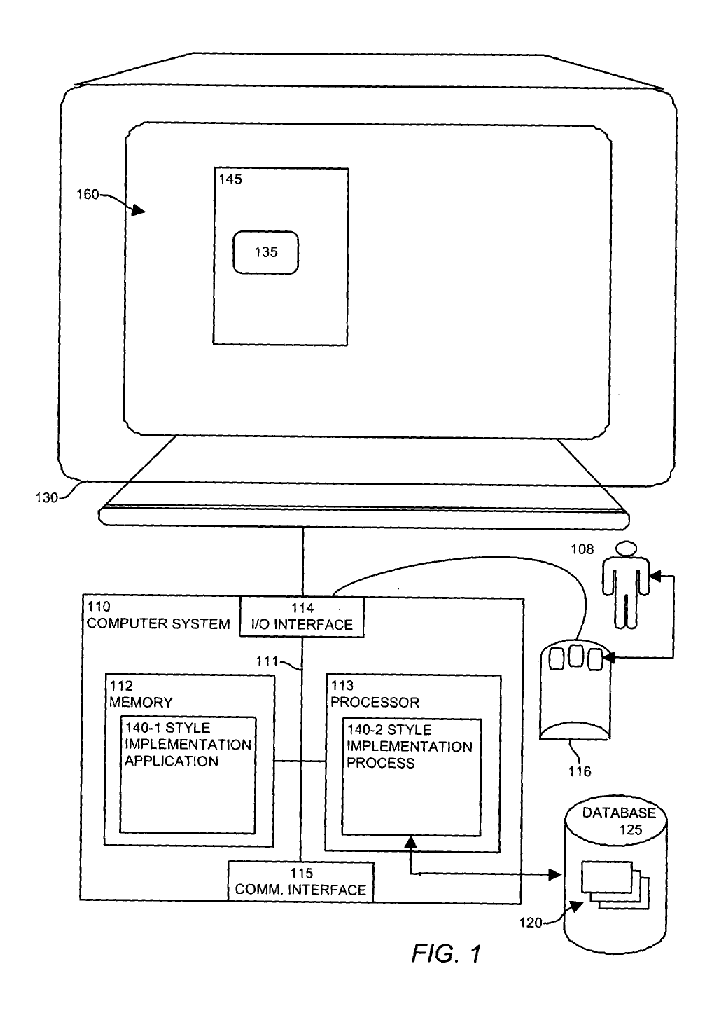

FIG. 1 is a block diagram illustrating example architecture of a computer system 110 that executes, runs, interprets, operates or otherwise performs a style implementation application 140-1 and process 140-2 suitable for use in explaining example configurations disclosed herein. The computer system 110 may be any type of computerized device such as a personal computer, workstation, portable computing device, console, laptop, network terminal or the like. As shown in this example, the computer system 110 includes an interconnection mechanism 111 such as a data bus or other circuitry that couples a memory system 112, a processor 113, an input/output interface 114, and a communications interface 115. An input device 116 (e.g., one or more user/developer controlled devices such as a keyboard, mouse, etc.) couples to processor 113 through I/O interface 114 and enables a user 108 such as a graphics design developer to provide input commands and generally control the graphical user interface 160 that the style implementation application 140-1 and process 140-2 provides on the display 130. Also in this example configuration, a database 125 stores defined styles 120 developed in accordance with techniques described herein within a computer readable medium. The communications interface 115 enables the computer system 110 to communicate with other devices (i.e., other computers) on a network (not shown). This can allow access to the style implementation application by remote computer systems.

The memory system 112 is any type of computer readable medium and in this example is encoded with a style implementation application 140-1 that supports generation, display, and implementation of functional operations of the graphical user interface 160 as explained herein. The style implementation application 140-1 may be embodied as software code such as data and/or logic instructions (e.g., code stored in the memory or on another computer readable medium such as a removable disk) that supports processing functionality according to different embodiments described herein. During operation of the computer system 110, the processor 113 accesses the memory system 112 via the interconnect 111 in order to launch, run, execute, interpret or otherwise perform the logic instructions of the style implementation application 140-1. Execution of style implementation application 140-1 in this manner produces processing functionality in a style implementation process 140-2. In other words, the style implementation process 140-2 represents one or more portions or runtime instances of the style implementation application 140-1 (or the entire application 140-1) performing or executing within or upon the processor 113 in the computerized device 110 at runtime. The style implementation process 140-2 operates as explained herein to implement styles on a document 145 containing display elements 135 within the graphical user interface 160. The user 108 creates a document 145 containing display elements 135. The user selects a display element 135, and applies to the display element 135, the appropriate attributes defined within the stored defined style 120, to format the display element 135.

It is noted that example configurations disclosed herein include the style implementation application 140-1. The style implementation application 140-1 may be stored on a computer readable medium (such as a floppy disk), hard disk, electronic, magnetic, and optical or other computer readable medium. The style implementation application 140-1 may also be stored in a memory system 112 such as in firmware, read only memory (ROM), or, as in this example, as executable code in, for example, Random Access Memory (RAM). In addition to these embodiments, it should also be noted that other embodiments herein include the execution of the style implementation application 140-1 in the processor 113 as the style implementation process 140-2. Those skilled in the art will understand that the computer system 110 may include other processes and/or software and hardware components, such as an operating system not shown in this example.

A display 130 need not be coupled directly to computer system 110. For example, the style implementation application 140-1 can be executed on a remotely accessible computerized device via the network interface 115. In this instance, the graphical user interface 160 may be displayed locally to a user of the remote computer and execution of the processing herein may be client-server based.

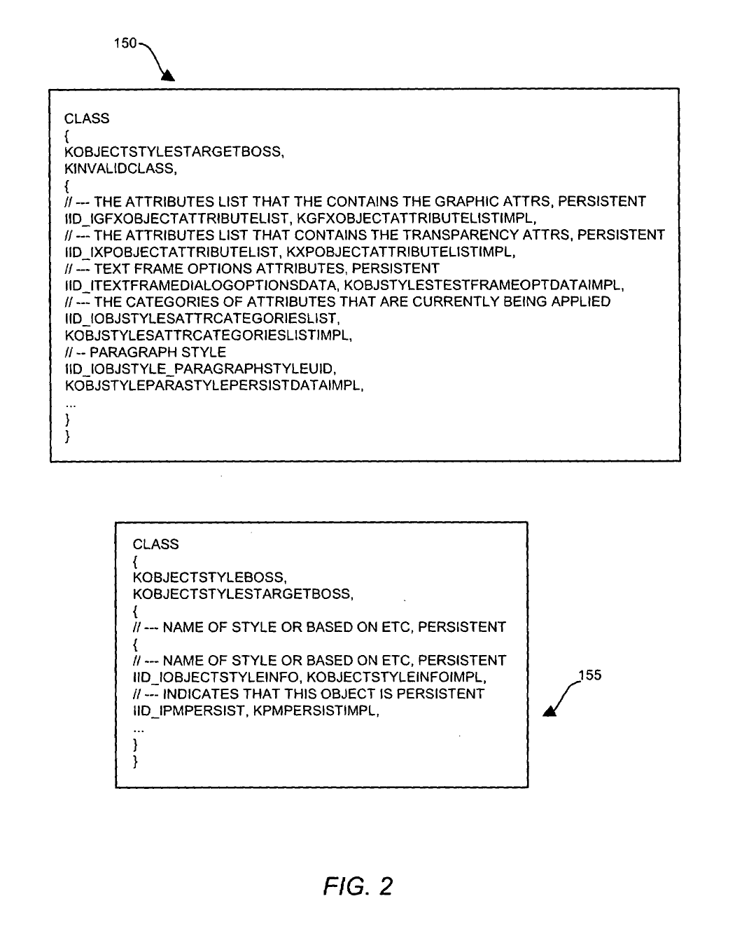

FIG. 2 shows coding examples of both a style 155 and style data 150 defined by the style implementation process 140-2. In one embodiment, the style 155 is implemented using object-oriented code in a programming language such as C++, Java or the like that supports object-oriented programming. Thus, the style 155 is a style object and the style data 150 is a style data object. The user 108 defines a style data object 150 containing lists of attributes (i.e., graphics, transparencies, frame options, etc) for different types of display elements. Next, the user 108 derives the style object 155 from the style data object 150. The style object 155 inherits the attributes defined within the style data 150. The style data object 150 is a non-persistent object, meaning it is not stored in the database 125. The style object 155 is a persistent object, meaning it is stored in the database 125 as a stored defined style 120.

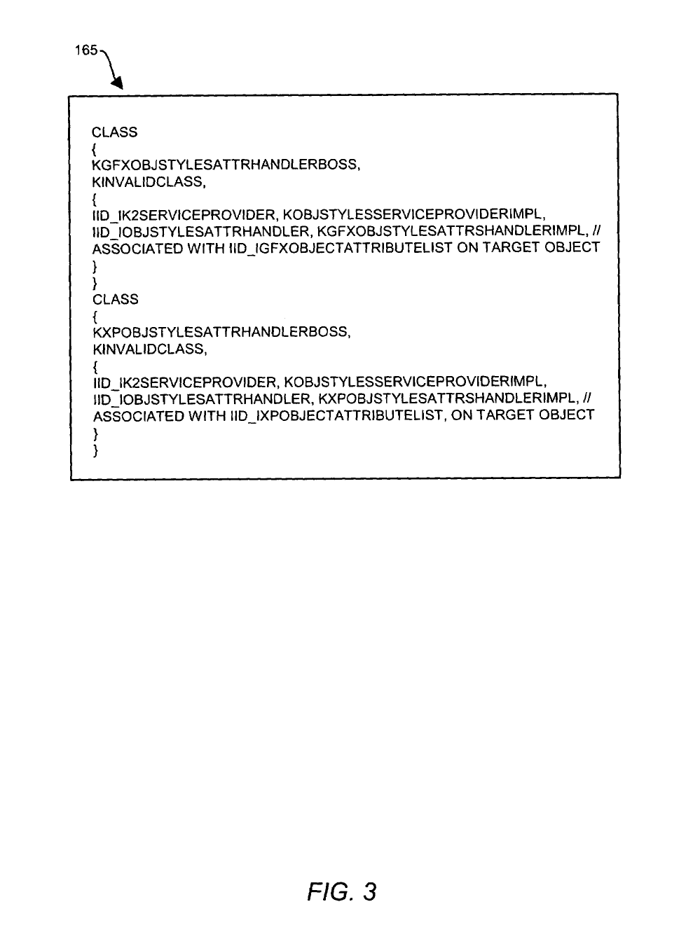

FIG. 3 shows a coding example of a style handler 165 defined by the style implementation process 140-2. In one embodiment, the style 155 is implemented using object-oriented code. Thus, the style handler 165 is a style handler object. Each style handler 165 is derived from a generic style handler interface, and then registered with a service provider. A unique style handler 165 is defined for each data interface within the style data 150. The style handler 165 interfaces with its associated data interface to access data on the style data 150.

Further details of configurations explained herein will now be provided with respect to a flow chart of processing steps that show the high level operations disclosed herein to perform the style implementation process 140-2.

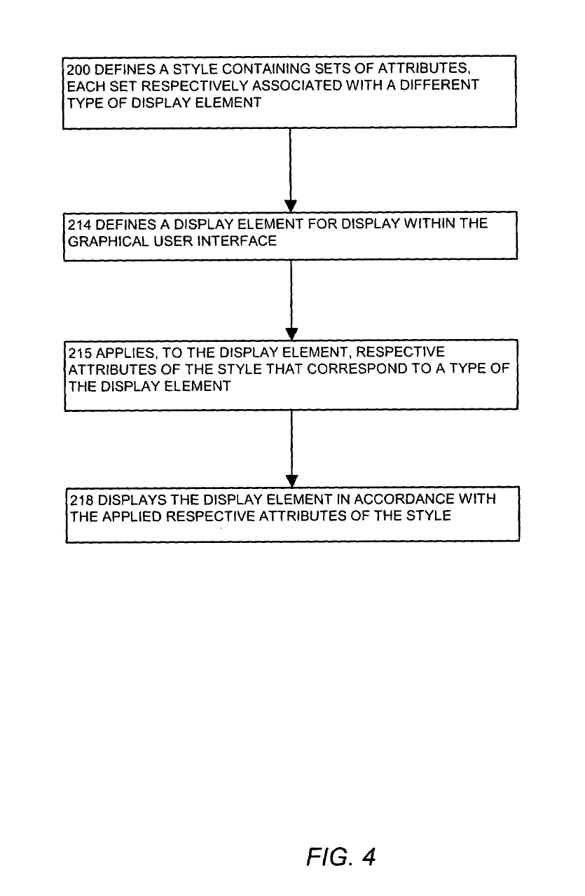

FIG. 4 is a flowchart of the steps performed by the style implementation process 140-2 when it defines a style 155 containing sets of attributes, defines a display element, applies the attributes to the display element and then displays the display element within a graphical use interface.

In step 200, the style implementation process 140-2 defines a style 155 containing sets of attributes, each set respectively associated with a different type of display element 135. Thus, a style 155 can contain attributes that can be applied to a variety of display elements (i.e., graphics, images, frames, text, etc).

In step 214, the style implementation process 140-2, via the user 108, defines a display element 135 for display within the graphical user interface 160. The user 108 defines the display element 135 by either typing text into a document 145, or inserting graphics, images, frames, etc into the document 145 via functions provided by the graphical user interface 160.

In step 215, the style implementation process 140-2 applies, to the display element 135, respective attributes of the style 155 that correspond to a type of the display element 135. Once the user 108 has defined the display element 135 in the document 145 within the graphical user interface 160, the user 108 chooses from the attributes within the style 155 that can be applied to that particular type of display element 135, and applies those attributes to the display element 135.

In step 218, the style implementation process 140-2 displays the display element 135 in accordance with the applied respective attributes of the style 155. After the user 108 has applied the chosen attributes of the style 155 to the display element 135, the style implementation process 140-2 displays that display element 135 with the chosen attributes.

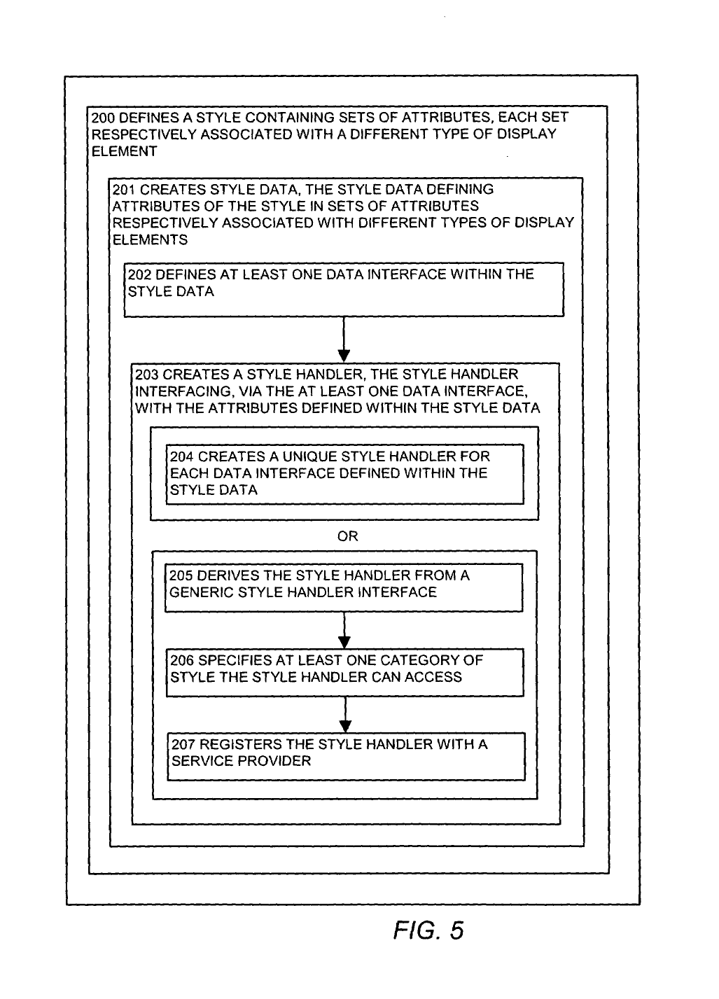

FIG. 5 is a flowchart of the steps performed by the style implementation process 140-2 when it defines a style 155 containing sets of attributes, each set respectively associated with a different type of display element 135. The style implementation process 140-2 creates style data 150, and a style handler 165. The style handler 165 is used to access the data within the style data 150.

In step 201, the style implementation process 140-2 creates style data 150, the style data 150 defining attributes of the style 155 in sets of attributes respectively associated with different types of display elements 135. Each set of attributes can be applied to a specific type of data element 135. Thus, there is a different set of attributes for graphics, transparencies, frame options, etc. In one embodiment, some of the attributes can be applied to more than one type of data element 135. For example, attributes that apply to a graphic's frame can also be applied to a text frame.

In step 202, the style implementation process 140-2 defines at least one data interface within the style data 150. The style data 150 contains data interfaces with which to access the data in the style data 150, via a style handler 165, the details of which will be further explained within the steps of 203 through 207.

In step 203, the style implementation process 140-2 creates a style handler 165, the style handler 165 interfacing, via the at least one data interface, with the attributes defined within the style data 150. The style handler 165 is used to fill in the data within the style data 150. In one embodiment, the style handler 165 handles more than one data interface.

In one embodiment, in step 204, the style implementation process 140-2 creates a unique style handler 165 for each data interface defined within the style data 150. Each data interface within the style data 150 has an associated style handler 165 that accesses data within the style data 150 via the data interfaces.

In step 205, the style implementation process 140-2 derives the style handler 165 from a generic style handler interface. In one embodiment, the style 155 is implemented using object-oriented code, creating a style object 155. The style handler 165 is an object-oriented style handler object 165 that is derived from a base style handler class object. Thus, each style handler 165 follows the same protocol for accessing data on the style data 150.

In step 206, the style implementation process 140-2 specifies at least one category of style 155 the style handler 165 can access. Each style handler 165 specifies which categories the style handler 165 can accept.

In step 207, the style implementation process 140-2 registers the style handler 165 with a service provider. The style implementation process 140-2 can iterate through all of the registered style handlers 165 to access data on the style data 150.

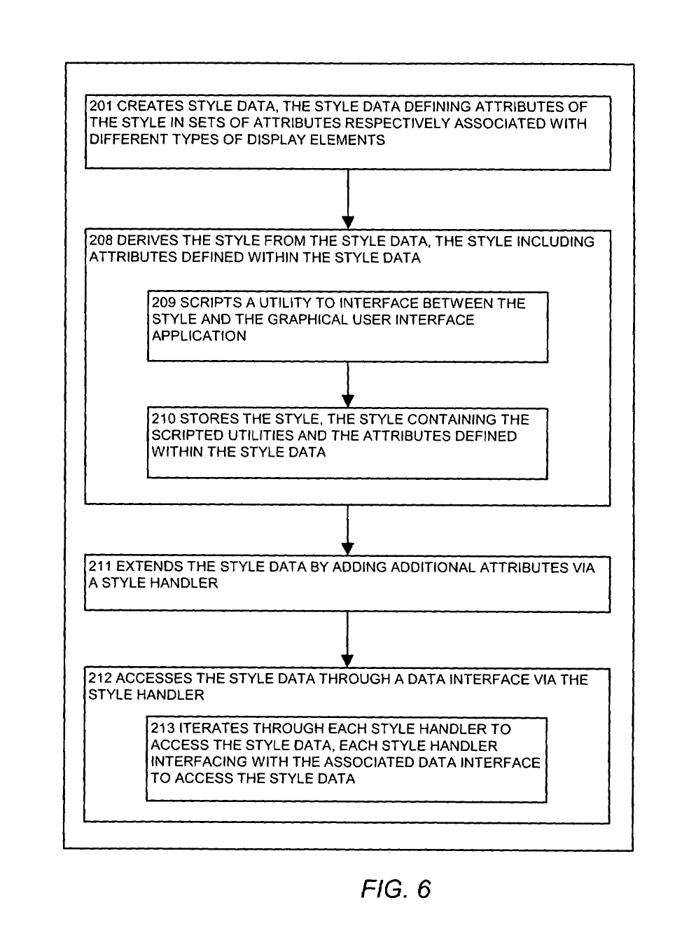

FIG. 6 is a flowchart of the steps performed by the style implementation process 140-2 when it creates the style 155 by deriving the style 155 from the style data 150. To edit or create the style 155, the style data 150 is populated with data via the style handlers 165, and the style 155 is derived from the style data 150. In one embodiment, the style data 150 the style handler 165 uses is generated through the graphical user interface 160, and passed to the style handler 165.

In step 208, the style implementation process 140-2 derives the style 155 from the style data 150, the style 155 including attributes defined within the style data 150. In one embodiment, both the style data 150 and the style 155 are defined as object-oriented code. Once the style data object 150 is defined, the style object 155 is derived from the style data object 150, inheriting the sets of attributes defined within the style data object 150.

In step 209, the style implementation process 140-2 scripts a utility to interface between the style 155 and the graphical user interface application. This scripting provides a method by which functions are implemented between the style 155 and the document 145.

In step 210, the style implementation process 140-2 stores the style 155 containing the scripted utilities and the attributes defined within the style data 150. The style 155 is stored (as a stored defined style 120) within the database 125.

In one embodiment, in step 211, the style implementation process 140-2 extends the style data 150 by adding additional attributes via a style handler 165. Once a style 155 is created, it can be updated/modified/extended by accessing the style data 150 via the registered style handlers 165.

In step 212, the style implementation process 140-2 accesses the style data 150 through a data interface via the style handler 165. Every data interface on the style data 150 has an associated registered style handler 165, specifically for that data interface.

Alternatively, to access data in the style data 150, in step 213, the style implementation process 140-2 iterates through each registered style handler 165 to access the style data 150, each style handler 165 interfacing with the associated data interface to access the style data 150.

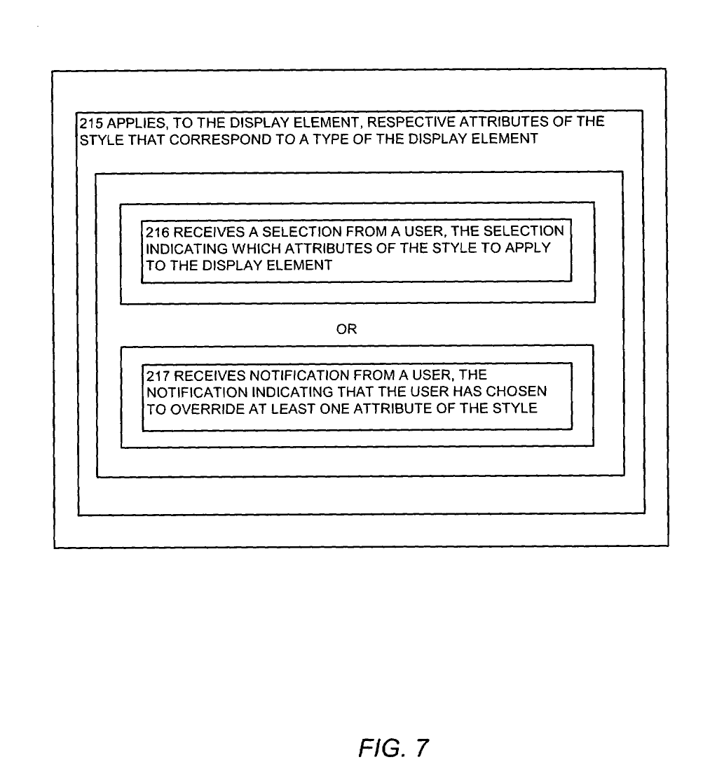

FIG. 7 is a flowchart of the steps performed by the style implementation process 140-2 when it, applies, to the display element 135, the attributes selected by the user 108. The user 108 places display elements 135 within the document 145. The user 108 then formats those display elements 135 by applying attributes associated with that type of display element 135.

In step 216, the style implementation process 140-2 receives a selection from a user 108, the selection indicating which attributes of the style 155 to apply to the display element 135. The user 108 can choose which of the attributes defined within the style 155, to apply to the display element 135. In one embodiment, the style handler 165 also handles the applying of the style data 150 to the display element 135. The style handler 165 serves two purposes. One purpose is to collect and store the data in the style data 150 (by editing the data interfaces). The second purpose is to apply the style data 150 to the display element 135.

Alternatively, in step 217, the style implementation process 140-2 receives notification from a user 108, the notification indicating that the user 108 has chosen to override at least one attribute of the style 155. The user 108 can choose to override the attributes defined within the style 155, when formatting the display element 135.

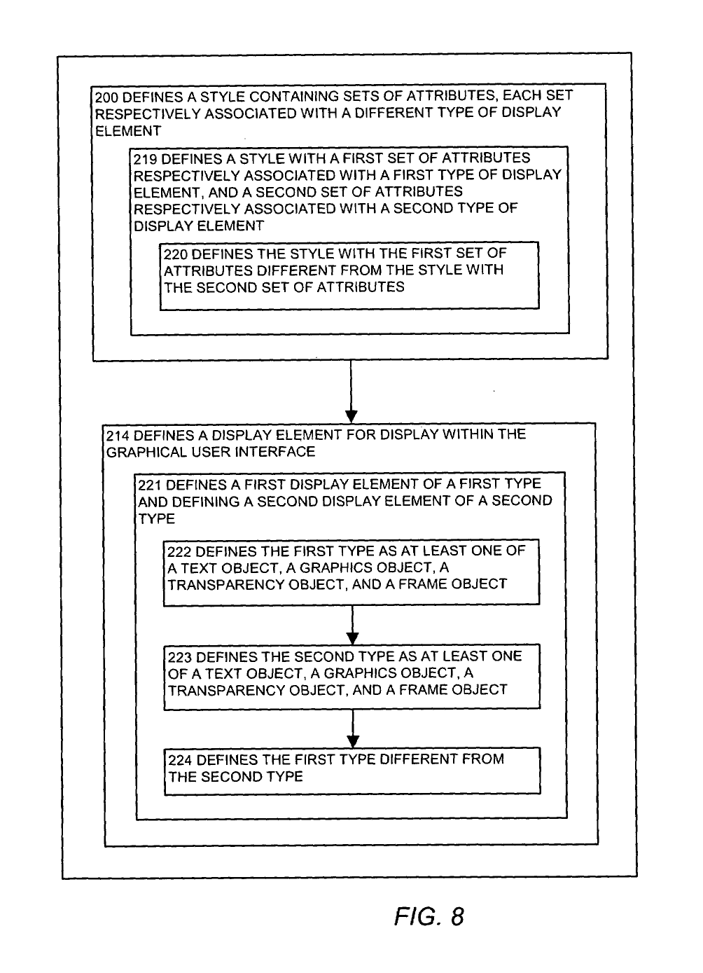

FIG. 8 is a flowchart of the steps performed by the style implementation process 140-2 when it defines a style 155 containing sets of attributes. Each set of attribute is associated with a type of display element 135.

In step 219, the style implementation process 140-2 defines a style 155 with a first set of attributes respectively associated with a first type of display element 135, and a second set of attributes respectively associated with a second type of display element 135. The style data 150 contains sets of attributes, for example, a first set of attributes for a first display element 135 and a second set of attributes for a second display element 135.

In step 220, the style implementation process 140-2 defines the style 155 with the first set of attributes different from the style 155 with the second set of attributes. The first set of attributes for the first display element 135 is different from the second set of attributes for the second display element 135.

In step 221, the style implementation process 140-2 defines a first display element 135 of a first type and defines a second display element 135 of a second type. Within the graphical user interface 160, the user 108 applies display elements 135 within a document 145. In one configuration, the first display element 135 is of a first type and the second display element 135 is of a second type.

In step 222, the style implementation process 140-2 defines the first type as at least one of a text object, a graphics object, and a frame object. The first display element 135 defined as a first type is at least one of a graphics object, a transparency object, and a frame object.

In step 223, the style implementation process 140-2 defines the second type as at least one of a text object, a graphics object, and a frame object. The second display element 135 defined as a second type is at least one of a graphics object, a transparency object, and a frame object.

In step 224, the style implementation process 140-2 defines the first type different from the second type. The first display element 135 of a first type is different than the second display element 135 of a second type.

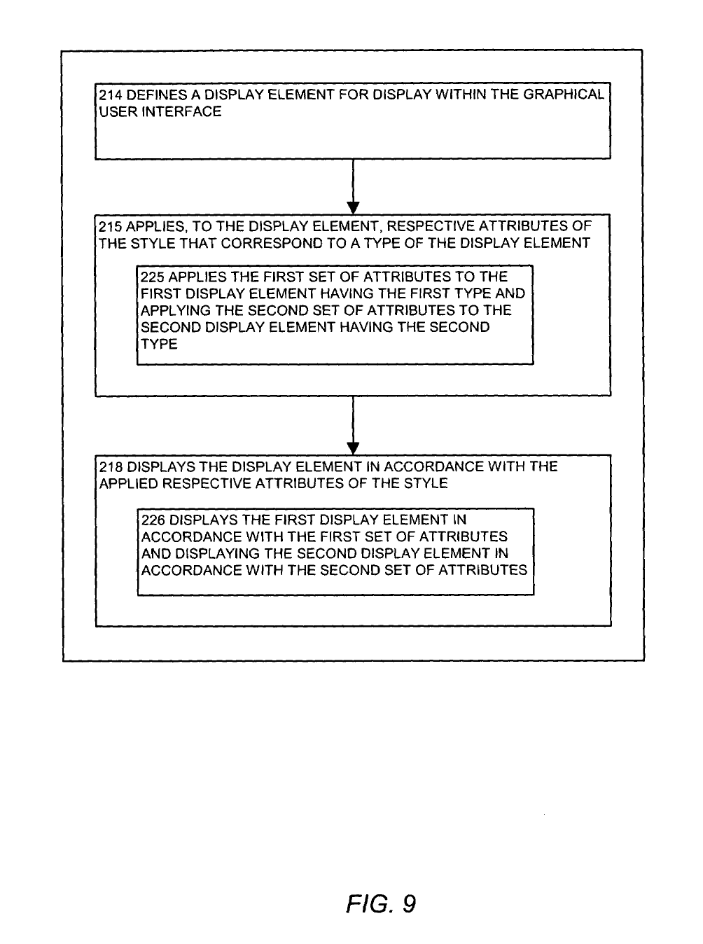

FIG. 9 is a flowchart of the steps performed by the style implementation process 140-2 when it applies, to the display element 135, respective attributes of the style that corresponds to a type of that display element 135. The style implementation process 140-2 receives the attributes selection chosen by the user 108, and applies those chosen attributes to the display element 135.

In step 225, the style implementation process 140-2 applies the first set of attributes to the first display element 135 having the first type and applying the second set of attributes to the second display element 135 having the second type. The style implementation process 140-2 receives the first set of attributes, chosen by the user 108 and applies that first set of attributes to the first display element 135. Then, the style implementation process 140-2 receives the second set of attributes, chosen by the user 108 and applies that second set of attributes to the second display element 135.

In step 226, the style implementation process 140-2 displays the first display element 135 in accordance with the first set of attributes and displays the second display element 135 in accordance with the second set of attributes. The style implementation process 140-2 displays the first display element 135 formatted with the first set of attributes, and the second display element 135 formatted with the second set of attributes.

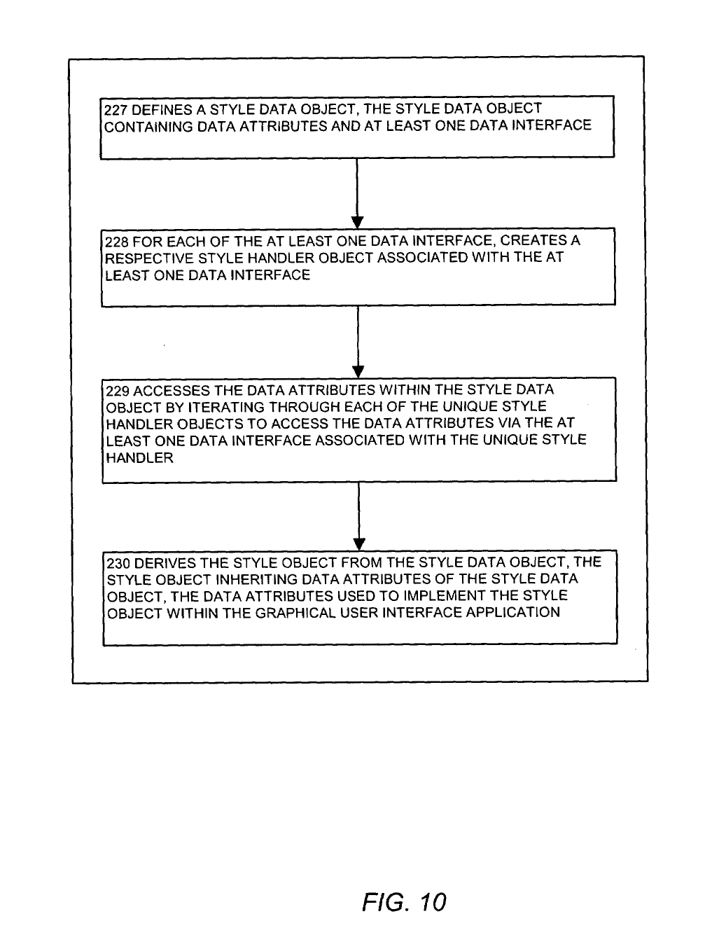

FIG. 10 is a flowchart of the steps performed by the style implementation process 140-2 when it defines a style 155 within an object-oriented environment. The style implementation process 140-1 defines a style data object 150, and then derives the style object 155 from the style data object 155.

In step 227, the style implementation process 140-2 defines a style data object 150. The style data object 150 contains data attributes, and at least one data interface.

The style data object 150 contains data attributes for different types of display elements.

In step 228, for each of the at least one data interface, the style implementation process 140-2 creates a respective style handler object 165 associated with the at least one data interface. The style handler object 165 is derived from a base style handler object class. Each style handler object 165 specifies which category the style handler object 165 can accept.

In step 229, the style implementation process 140-2 accesses the data attributes within the style data object 150 by iterating through each of the unique style handler objects 165 to access the data attributes via the at least one data interface associated with the unique style handle 165. To fill the style data object 150 with data, the style implementation process 140-2 accesses the data interfaces via the associated style handler object 165.

In step 230, the style implementation process 140-2 derives the style object 155 from the style data object 150, the style object 155 inheriting data attributes of the style data object 150, the data attributes used to implement the style object 155 within the graphical user interface application. The style object 155 is derived from the style data object 150, inheriting the attributes data defined when filling the style data object 150 with data, via the style handler objects 165.

While computer systems and methods have been particularly shown and described above with references to configurations thereof, it will be understood by those skilled in the art that various changes in form and details may be made therein without departing from the scope disclosed herein. Accordingly, embodiments disclosed herein are not intended to be limited by the example configurations provided above.

1. A method of implementing a style within a graphical user interface application, the method comprising:
defining a style containing sets of attributes, wherein (i) a first set of attributes is defined for formatting a display element of a first document element type and (ii) a second set of attributes is defined for formatting a display element of a second document element type, the first document element type different than the second document element type;
defining a display element for display in a document within the graphical user interface, wherein defining the display element comprises:
receiving a first display element of the first document element type;
applying to the first display element respective attributes from the style's first set of attributes; and
displaying the first display element in the document as formatted according to the style's first set of attributes;
wherein applying, to the first display element in the document, attributes from the style's first set of attributes comprises:
receiving an update for the style, the update for modifying at least one attribute in the first set of attributes;
receiving a notification, the notification indicating the user has a choice to override the update for the style;
in response to receiving the notification, maintaining the first display element as formatted with a prior version of the attribute intended to be modified according to the update;
identifying a second display element of the second document element type currently rendered in the document, the second display element formatted according to the style's second set of attributes;
applying the update to the style's second set of attributes; and
modifying an appearance of the second display element by formatting the second display element according to an updated second set of attributes.

2. The method of claim 1 wherein defining a style comprises:
creating style data, the style data defining attributes of the style in sets of attributes respectively associated with different types of display elements; and
deriving the style from the style data, the style including attributes defined within the style data.

3. The method of claim 2 wherein creating a style data comprises:
defining at least one data interface within the style data; and
creating a style handler, the style handler interfacing, via the at least one data interface, with the attributes defined within the style data.

4. The method of claim 3 wherein creating a style handler comprises:
creating a unique style handler for each data interface defined within the style data.

5. The method of claim 3 wherein creating a style handler comprises:
deriving the style handler from a generic style handler interface;
specifying at least one category of style the style handler can access; and
registering the style handler with a service provider.

6. The method of claim 2 wherein deriving the style comprises:
scripting a utility to interface between the style and the graphical user interface application; and
storing the style, the style containing the scripted utilities and the attributes defined within the style data.

7. The method of claim 2 comprising:
extending the style data by adding additional attributes via a style handler; and
accessing the style data through a data interface via the style handler.

8. The method of claim 7 wherein accessing the style data comprises:
iterating through each style handler to access the style data, each style handler interfacing with the associated data interface to access the style data.

9. (canceled)

10. (canceled)

11. (canceled)

12. (canceled)

13. (canceled)

14. (canceled)

15. A computerized device comprising:
a memory;
a processor;
a communications interface;
an interconnection mechanism coupling the memory, the processor and the communications interface;
where the memory is encoded with a style implementation application that when executed on the processor implements a style within a graphical user interface application in the computerized device by performing the operations of:
defining a style containing sets of attributes, wherein (i) a first set of attributes is defined for formatting a display element of a first document element type and (ii) a second set of attributes is defined for formatting a display element of a second document element type, the first document element type different than the second document element type;
defining a display element for display in a document within the graphical user interface, wherein defining the display element comprises includes:
receiving, a first display element of the first document element type;
applying to the first display element respective attributes from the style's first set of attributes; and
displaying the first display element in the document as formatted according to the style's first set of attributes;
wherein applying, to the first display element in the document, attributes from the style's first set of attributes comprises:
receiving an update for the style, the update for modifying at least one attribute in the first set of attributes;
receiving a notification from the user, the notification indicating the user has a choice to override the update for the style;
in response to receiving the notification, maintaining the first display element as formatted with a prior version of the attribute intended to be modified according to the update;
identifying a second display element of the second document element type currently rendered in the document, the second display element formatted according to the style's second set of attributes;
applying the update to the style's second set of attributes; and
modifying an appearance of the second display element by formatting the second display element according to an updated second set of attributes.

16. The computerized device of claim 15 wherein when the computerized device performs the operation of defining a style, the computerized device performs the operations of:
creating style data, the style data defining attributes of the style in sets of attributes respectively associated with different types of display elements; and
deriving the style from the style data, the style including attributes defined within the style data.

17. The computerized device of claim 16 wherein when the computerized device performs the operation of creating a style data, the computerized device performs the operations of:
defining at least one data interface within the style data; and
creating a style handler, the style handler interfacing, via the at least one data interface, with the attributes defined within the style data.

18. The computerized device of claim 17 wherein when the computerized device performs the operation of creating a style handler, the computerized device performs the operation of:
creating a unique style handler for each data interface defined within the style data.

19. The computerized device of claim 17 wherein when the computerized device performs the operation of creating a style handler, the computerized device performs the operations of:
deriving the style handler from a generic style handler interface;
specifying at least one category of style the style handler can access; and
registering the style handler with a service provider.

20. The computerized device of claim 16 wherein when the computerized device performs the operation of deriving the style, the computerized device performs the operations of:
scripting a utility to interface between the style and the graphical user interface application; and
storing the style, the style containing the scripted utilities and the attributes defined within the style data.

21. The computerized device of claim 16 wherein the computerized device performs the operations of:
extending the style data by adding additional attributes via a style handler; and
accessing the style data through a data interface via the style handler.

22. The computerized device of claim 21 wherein when the computerized device performs the operation of accessing the style data, the computerized device performs the operation of:
iterating through each style handler to access the style data, each style handler interfacing with the associated data interface to access the style data.

23. (canceled)

24. (canceled)

25. (canceled)

26. (canceled)

27. (canceled)

28. A non-transitory computer readable storage medium including computer program logic encoded thereon that, when executed in a computerized device, implements a style within a graphical user interface application by causing the computerized device to perform the operations of:
defining a style containing sets of attributes, wherein (i) a first set of attributes is defined for formatting a display element of a first document element type and (ii) a second set of attributes is defined for formatting a display element of a second document element type, the first document element type different than the second document element type;
defining a display element for display in a document within the graphical user interface, wherein defining the display element comprises:
receiving a first display element of the first document element type;
applying, to first display element received from the user, respective attributes from the style's first set of attributes; and
displaying the first display element, received from the user, in the document as formatted according to the style's first set of attributes;
wherein applying, to the first display element in the document, attributes from the style's first set of attributes comprises:
receiving an update for the style, the update for modifying at least one attribute in the first set of attributes;
receiving a notification from the user, the notification indicating the user has a choice to override the update for the style;
in response to receiving the notification, maintaining the first display element as formatted with a prior version of the attribute intended to be modified according to the update;
identifying a second display element of the second document element type currently rendered in the document, the second display element formatted according to the style's second set of attributes;
applying the update to the style's second set of attributes; and
modifying an appearance of the second display element by formatting the second display element according to an updated second set of attributes.

29. (canceled)

30. (canceled)

31. (canceled)

32. (canceled)

33. (canceled)

34. (canceled)

35. (canceled)

36. (canceled)

37. (canceled)

38. The method as in claim 1, comprising:
wherein the first document element type and the second document element type each comprise one from a group of: a document graphics type, a document image type, a document frames type, and a document text type.

39. The method as in claim 1, wherein receiving the update comprises:
receiving the update from a third party provider registered to update the style via a style interface, the third party provider being different than the user that selected the first display element.

40. The method as in claim 39, wherein receiving the update from the third party provider comprises:
receiving an additional attribute to be added to each of the style's respective set of attributes corresponding to a type of document display element, wherein at least one set from the style's respective set of attributes currently comprises at least one attribute defined by an original source of the style.

41. The method as in claim 1, comprising:
upon determining the notification has not been received, modifying the style's first set of attributes according to the update; and
incorporating a modified attribute from style's an updated first set of attributes into a current formatting of the first display element.

42. The method as in claim 1, comprising:
upon determining the notification has not been received, modifying the style's first set of attributes according to the update; and
incorporating a modified attribute from style's an updated first set of attributes into a current formatting of the first display element;
wherein receiving the update comprises:
receiving the update from a third party provider registered to update the style via a style interface, the third party provider being different than the user that selected the first display element and a user that selected the second display element, wherein the first document element type and the second document element type each comprise one from a group of: a document graphics type, a document image type, a document frames type, and a document text type; and
wherein receiving the update from the third party provider comprises:
receiving an additional attribute to be added to each of the style's respective set of attributes corresponding to a type of document display element, wherein at least one set from the style's respective set of attributes currently comprises at least one attribute defined by an original source of the style.

43. A method of implementing a style within a graphical user interface application, the method comprising:
defining a formatting style that comprises sets of attributes, each set of attributes is respectively defined for formatting a first display element and a second display element, the attributes of the first display element being different than the attributes of the second display element, the first and second display elements are text, an image, a graphic or a frame;
displaying the first display element and the second display element on the graphical user interface, the first display element and the second display element being displayed in a plurality of instances on the graphical user interface;
applying a set of attributes to the first display element and a different set of attributes to the second display element, each of the plurality of instance of the first display element and the second display element being displayed as formatted according to their applied set of attributes.
